(19) United States
(12) Patent Application Publication
(10) Pub. No.: US 2026/0118854 A1
(43) Pub. Date: Apr. 30, 2026

(54) AUTOMATIC PLACEMENT OF EQUIPMENT IN AN INDUSTRIAL PLANT USING MACHINE LEARNING TECHNIQUES

(71) Applicant: AspenTech Corporation, Bedford, MA (US)

(72) Inventors: Soroush Famili, Revere, MA (US); Krishnan Kumaran, Raritan, NJ (US); Junwei Luo, North Billerica, MA (US); Sameer Suhas Marathe, Reading, MA (US); Eric Lira Berra, Mexico City (MX); Ignacio Lopez, Mexico City (MX); Sonali Singh, Moraga, CA (US)

(21) Appl. No.: 18/931,393

(22) Filed: Oct. 30, 2024

(51) Int. Cl. G05B 19/418

(52) U.S. Cl. CPC G05B 19/4184; G05B 19/41885

(57) ABSTRACT

Embodiments disclosed herein provide methods, systems, and computer program products for determining layouts of objects in environments. An example method includes, by a processor, receiving, in memory, (i) an indication of the set of objects, (ii) an indication of characteristics of the environment, and (iii) one or more criteria. The received indication of the set of objects and the one or more criteria are used to determine a priority order of each object in the set of objects. In turn, the layout of the set of objects is determined by, in the determined priority order, iteratively selecting a location for each object.

### BACKGROUND

Optimal placement of objects in a space subject to constraints is a very difficult problem. The placement of objects in a space is a variation of the well-known bin-packing problem, which is known to be NP-hard. In other words, an exact solution cannot be found in a reasonable amount of time.

### SUMMARY

Embodiments solve this problem and provide improved methods, systems, and computer program products for determining object layouts in environments.

Example embodiments may employ unique machine learning methods to determine object layouts. Machine learning methods offer more flexibility and ease of use compared to traditional optimization methods to solve such difficult equipment layout problems. However, most machine learning methods applied to such problems are not generally interpretable in the sense that the solutions the machine learning methods provide cannot be easily explained by a human user. Embodiments solve this problem and determine interpretable layouts.

Embodiments determine near-optimal placements of objects, e.g., equipment in the context of Aspen OptiPlant® (by Applicant-Assignee AspenTech Corporation). Embodiments may use scoring functions and heatmaps to guide the placement of equipment. This results in near-optimal placements in a fraction of the time it would take to find the optimal solution, if it exists.

An example embodiment is directed to a computer-implemented method of determining a layout of a set of objects in an environment. The method includes, by a processor, receiving, in memory, (i) an indication of the set of objects, (ii) an indication of characteristics of the environment, and (iii) one or more criteria. The received indication of the set of objects and the one or more criteria are used to determine a priority order of each object in the set of objects. In turn, the layout of the set of objects is determined by, in the determined priority order, iteratively selecting a location for each object. According to such an embodiment, selecting the location for each object comprises: (i) based on the received indication of characteristics of the environment, determining available locations in the environment, (ii) based on at least one of the received indication of characteristics of the environment and the one or more criteria, assigning one or more scores to each determined available location in the environment for the object, and (iii) based on the assigned one or more scores of each determined available location for the object, selecting a given location for the object.

According to an embodiment, the one or more criteria includes at least one of: an indication of dimensions of an object, an indication of a grouping of objects, and an indication of a direct connection between objects.

In an embodiment, the characteristics of the environment comprise one or more of: distance of an object to a piperack, connectivity between two or more objects, an indication of a grouping of objects, and density of objects.

Yet another example embodiment further comprises generating a visualization of the environment indicating the assigned one or more scores for each determined available location for the object.

Another example embodiment further comprises receiving, in the memory, an indication of one or more key performance indicators and modifying the determined layout of the set of objects by iteratively modifying the location for each object. In such an embodiment, modifying the location for each object comprises: (i) based on the received indication of one or more key performance indicators, assigning one or more scores to each determined available location in the environment for the object and (ii) based on the assigned one or more scores of each determined available location for the object, modifying the location for the object. In one embodiment, the one or more key performance indicators is at least one of: amount of piping, layout size, production volume, and manufacturing cycle time.

In an embodiment, the set of objects is a set of equipment. In another embodiment, the set of equipment is a set of manufacturing equipment.

According to another embodiment, assigning the one or more scores to each determined available location in the environment for the object comprises: assigning a distance score, a connectivity score, a community score, and a density score to each determined available location in the environment.

Another embodiment is directed to a system for determining a layout of a set of objects in an environment. The system includes a processor and a memory with computer code instructions stored thereon. The processor and the memory, with the computer code instructions, are configured to cause the system to implement any embodiments or combination of embodiments described herein.

Yet another embodiment is directed to a computer program product for determining a layout of a set of objects in an environment. The computer program product comprises a computer readable medium with computer code instructions stored thereon where, the computer code instructions, when executed by a processor, cause an apparatus associated with the processor to perform any embodiments or combination of embodiments described herein.

It is noted that embodiments of the method, system, and computer program product may be configured to implement any embodiments, or combination of embodiments, described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flowchart of a method of determining a layout of a set of objects in an environment, according to an embodiment.

FIG. 2 is a workflow diagram illustrating a method embodiment for generating a layout of equipment in the presence of piperacks.

FIGS. 3A, 3B, and 4-7 are heatmaps indicating object layouts determined using various constraints, according embodiments.

FIG. 8 illustrates changes in equipment layout following key performance indicator (KPI) optimization according to an embodiment.

FIGS. 9A and 9B illustrate an example human designed layout and a layout generated by a method of the present disclosure, respectively.

FIGS. 10A and 10B illustrate an example human designed layout and a layout generated by a method of the present disclosure, respectively.

FIGS. 11A and 11B illustrate an example human designed layout and a layout generated by a method of the present disclosure, respectively.

FIGS. 12A-C illustrate example layouts generated using embodiments that employed different object priorities.

FIG. 13 depicts a computer network or similar digital processing environment in which embodiments of the present disclosure may be implemented.

FIG. 14 is a diagram of an example internal structure of a computer in the computer system of FIG. 13, according to an embodiment.

### DETAILED DESCRIPTION

A description of example embodiments follows.

The present disclosure generally relates to methods, systems, and computer program products for determining layouts for sets of objects in environments. As noted above, optimal placement of objects in a confined space subject to various constraints (i.e., determining object layouts) is a very difficult problem. Embodiments solve this problem and find near-optimal placements of objects, in particular equipment in the context of Aspen OptiPlant® as one example. It is noted that while example embodiments are described as operating in the context of Aspen OptiPlant®, such descriptions are merely illustrative examples and embodiments are not limited to being implemented in Aspen OptiPlant® or any particular software programs/platforms.

Embodiments may use heatmaps to guide the placement of equipment. Utilizing heatmaps results in near-optimal placements in a fraction of the time it would take to find an optimal solution, if it exists. Herein, “optimal layout” and “near-optimal layout” refers to layouts that are optimized for one or more metrics/contraints, e.g., an OptiPlant® metric, such as piping usage, and/or optimized to look like it was designed by a human, etc.

Embodiments may use multiple, independent scoring functions that assign scores to each location in a layout, e.g., an OptiPlant® layout. An example embodiment calculates an aggregated score for each location using the individual scoring functions. According to an embodiment, the larger the aggregated score is, the more “optimal” it would be to place the equipment at that location.

Additionally, because each location is given a score by each individual scoring function and the aggregate scoring function, embodiments can create visualizations of the scores using heatmap visualization. This offers a visual explanation as to why equipment is placed in particular locations. Such visualizations provide a more transparent explanation than existing methods.

Herein, the term “heatmap” is used to denote both a distribution of scores of a particular scoring function and a visualization of the distribution. The term “heatmap” and the term “scoring function” are also used interchangeably.

The following steps describe an example workflow to determine a layout according to an embodiment: (1) group and order the set of equipment based on connectivity, size, and priority; (2) place equipment groups in the order described in step 1 using heatmaps that prioritize locations by various criteria; (3) generate and compare multiple placements using specified key performance indicators (KPIs) such as piping usage, financial cost, etc.; and (4) optionally improve placement using local adjustments or machine learning methods such as greedy KPI Optimization and a genetic algorithm.

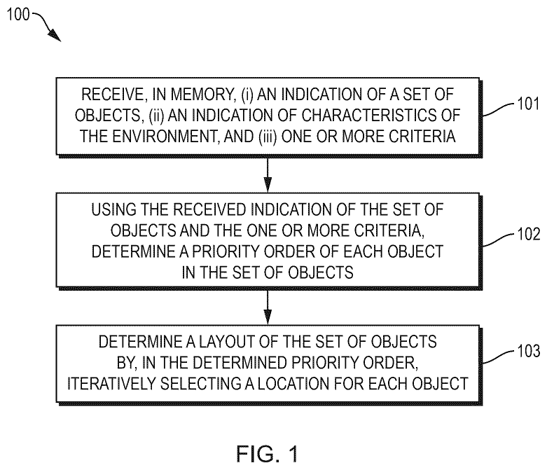

FIG. 1 is a flowchart of another example method 100 of determining a layout of a set of objects in an environment, according to an embodiment. The method 100 begins at step 101 by receiving, in memory of a processor (implementing the method 100), (i) an indication of the set of objects, (ii) an indication of characteristics of the environment, and (iii) one or more criteria. Next, at step 102, a priority order of each object in the set of objects is determined using the received indication of the set of objects and the one or more criteria. In turn, at step 103, a layout of the set of objects is determined in the priority order (determined at step 102), by iteratively selecting a location for each object.

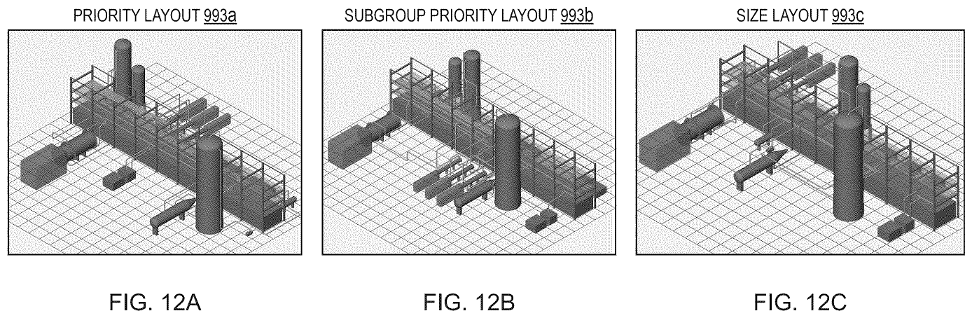

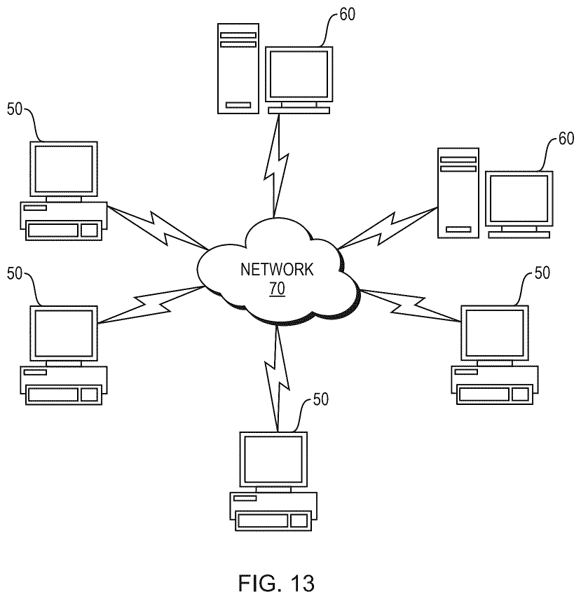

The method 100 is computer-implemented and, as such, the functionality and effective operations, e.g., the receiving (101), determining a priority order (102), and determining a layout (103), are automatically implemented by one or more digital processors. Moreover, the method 100 can be implemented using any computer device or combination of computing devices known in the art. Among other examples, the method 100 can be implemented using computer(s)/device(s) 50 and/or 60 described hereinbelow in relation to FIGS. 12 and 13.

The indications and criteria received at step 101 may be in the form of any data for any objects and any environment, including, but not limited to, numerical data.

In embodiments, the objects or environment may be any objects or environment known to those of skill in the art. For instance, the environment may include industrial environments (e.g., chemical plants such as acid gas removal units for natural gas processing, oil and gas facilities, power plants, manufacturing plants), municipal and urban environments (e.g., natural gas distribution, wastewater treatment plants), agricultural environments (e.g., irrigation systems, fertilizer distribution), residential and commercial buildings (e.g., plumbing systems, heating, fire suppression systems), and mining environments (e.g., ore slurry pipelines, dewatering systems), amongst other examples. Further, it is noted that because the method 100 is computer-implemented, the indications may be received at step 101 from any data storage or combination of data storage devices communicatively coupled or capable of being communicatively coupled, to a computing device implementing the method 100.

According to an embodiment of the method 100, the one or more criteria recevied at step 101 include at least one of: an indication of dimensions of an object, an indication of a grouping of objects, and an indication of a direct connection between objects. Further, in an embodiment, the characteristics of the environment received at step 101 comprise one or more of: distance of an object to a piperack, connectivity between two or more objects, an indication of a grouping of objects, and density of objects. In yet another embodiment, the set of objects is a set of equipment, such as manufacturing equipment.

At step 102, the indication of the set of objects and the one or more criteria are used to determine a priority order of the objects, e.g., an order in which to determine object location. In an embodiment, the indication of the set of objects provides a listing of the subject objects and the criteria indicates the factors to consider when determining the priority. the priority order is based on the importance of the object (e.g., equipment). For example, equipment placed down earlier will have better access to piperacks, better access to connected equipment, and fewer distance constraints to interfere with the object's placement. In addition to using the indication of the set of objects and the one or more criteria when determining the priority order at step 102, embodiments of the method 100 may also use characteristics of the environment. To illustrate, in an embodiment, objects may be assigned to various subgroups or communities (as indicated by the characteristics of the environment), and within each subgroup or community, the placement order of each member may be determined by priority. The set of objects may also be considered in its entirety and the priority order may be determined at step 102 without any subgroup or community assignments.

At step 103, the layout of a set of objects is determined by, in the determined priority order, iteratively selecting a location (e.g., gridpoints) for each object. According to an embodiment, selecting the location for each object comprises: (i) based on the received indication of characteristics of the environment, determining available locations in the environment (e.g., considering only viable areas for placement such as areas that are not obstructed by existing machinery or equipment), (ii) based on at least one of the received indication of characteristics of the environment and the one or more criteria, assigning one or more scores to each determined available location in the environment for the object (e.g., if an object has to be directly connected to a central piperack, locations near the central piperack would receive higher scores), and (iii) based on the assigned one or more scores of each determined available location for the object, selecting a given location for the object (e.g., if a location is assigned the highest score due to its accessibility to necessary fluids provided by a central piperack, that location is chosen for placement for the object, such as a heat exchanger). According to an embodiment, respective scores for each of the one or more criteria are assigned. For example, in an embodiment of the method 100 where criteria include distance, connectivity, community, and density, at step 103, assigning the one or more scores to each determined available location in the environment for the object includes assigning a distance score, a connectivity score, a community score, and a density score to each determined available location in the environment.

An embodiment of the method 100 further includes receiving, in the memory, an indication of one or more KPIs. Example KPIs include amount of piping, layout size, production volume, and manufacturing cycle time, amongst other examples. To continue, the determined layout of the set of objects is modified by iteratively modifying location for each object using the one or more KPIs. According to an embodiment, modifying the location of each object includes: (i) based on the received indication of one or more KPIs, assigning one or more scores to each determined available location in the environment for the object and (ii) based on the assigned one or more scores of each determined available location for the object, modifying the location of the object.

To illustrate, consider a chemical processing plant example. In this illustrative example, a location within a given layout for each equipment of a set of chemical processing plant equipment was determined, e.g., based on the amount of piping, layout size, and manufacturing cycle time. In turn, the determined locations are iteratively modified based on the KPI score of each location so as to determine updated locations for each equipment. In the determined layout of a set of equipment, equipment such as reactors, heat exchangers, and pumps may be assigned to locations closer to a central piperack in order to minimize the amount of piping. Equipment such as storage tanks and conveyor systems, which do not require continuous access to fluids, may be assigned to locations further away from the piperack, optimizing the size of the layout and manufacturing cycle time.

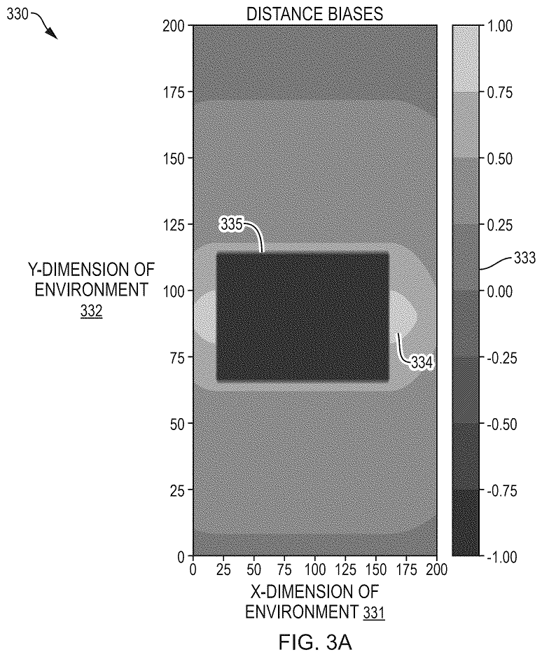

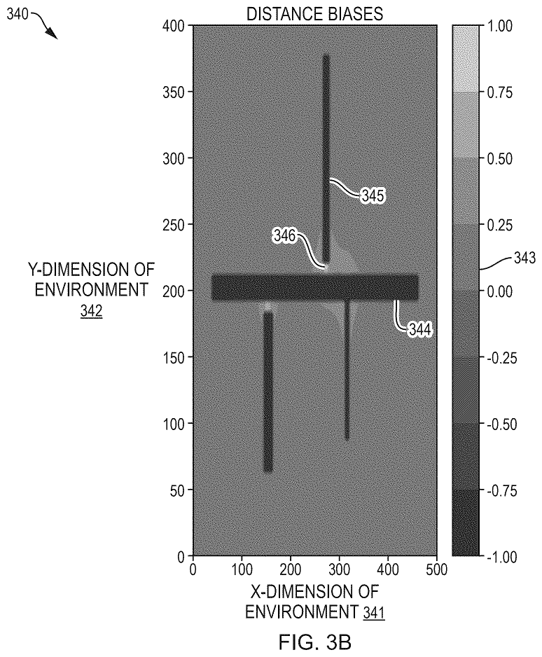

Embodiments of the method 100 may further include generating a visualization of the environment indicating the assigned one or more scores for each determined available location for the object. As such, each of the assigned one or more scores may be visualized using an individual heatmap. As used herein, the term “heatmap” denotes the visualization of the distribution of scores of a scoring function. According to an embodiment, a heatmap depicts the score at each gridpoint of an environment based on the corresponding scoring function. Examples of heatmaps are shown in FIGS. 3A, 3B and 4-7 and described hereinbelow.

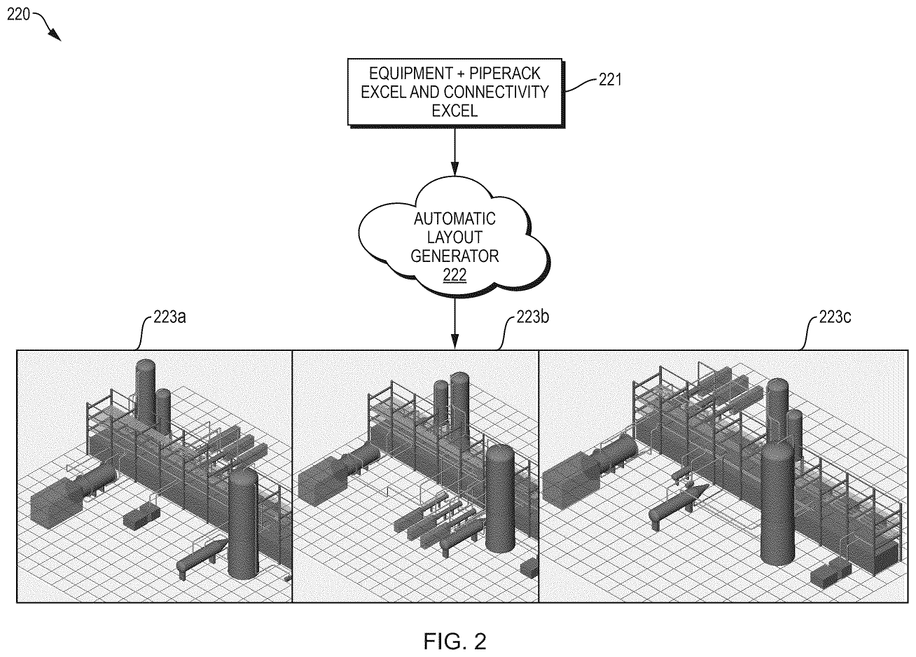

FIG. 2 is a workflow diagram illustrating a method embodiment 220 for generating a layout of equipment in the presence of piperacks. The method 220 begins by receiving 221 data related to equipment, piperacks, and connectivity (e.g., dimensions of equipment, distances between equipment and piperacks, whether equipment should be directly connected or not, etc.). In an embodiment, the data received 221 includes a binary pairwise matrix representing connectivity between equipment. In such an embodiment, if two pieces of equipment are directly connected (e.g., connected by pipes), a value of 1 is assigned; otherwise, a value of 0 is assigned. To continue, the data received 221 is used as input for automatic layout generation 222. According to an embodiment, the automatic layout generation 222 implements the method 100. In turn, the method 220 outputs, for example, one or more chemical plant layouts 223a-c.

To illustrate another embodiment, consider a 2D layout, e.g., an OptiPlant® layout, with discrete dimensions M×N, a set of objects (e.g., equipment E) which have already been placed in the layout, and an equipment q a user intends to place in the layout. Such an embodiment determines optimal coordinates (x,y) for placing equipment q within the layout, subject to various constraints.

Embodiments may utilize various constraints. For instance, an example constraint includes no overlapping of equipment. Equipment are physical objects and, thus, equipment cannot take up the same space. The no overlapping constraint enforces this idea. Another example constraint includes no distance constraint violations. Certain equipment need to be a certain distance away from each other. For example, flammable pumps must be at least 50 feet away from a furnace. The no distance constraint can be utilized to ensure required distances are achieved in layouts. Yet another example constraint includes no overlapping of equipment with piperacks. Piperacks, which are structures that are used to hold pipes, should not overlap with equipment. Piperacks may be present in a layout before placing down a piece of equipment. Thus, when placing down equipment, equipment are not allowed to overlap with piperacks. The foregoing constraint ensures this rule is not violated. It noted that the listed constraints are non-limiting examples and any rule, e.g., user desired rule, may be employed as a constraint.

Embodiments described herein may employ individual independent heatmaps, i.e., scoring functions. Each heatmap (scoring function) may implement a heuristic (e.g., a heuristic for designing chemical plants). Thus, in such an embodiment, when determining a location for a given object, multiple scoring functions are utilized to determine a respective score for each heuristic. Individual heatmaps (i.e., heuristic scores) can be aggregated to produce a final heatmap to determine where to place an object. According to an embodiment, each heatmap is a scoring function that maps a discrete coordinate (x,y) to a score in the range of [−1,1]. The higher the score, the more “optimal” a location is considered to be by the scoring function.

As noted above, embodiments may employ multiple heatmaps, i.e., scoring functions. Hereinbelow, in relation to FIGS. 3A, 3B, and 4-7, multiple different heatmaps are described. It is noted that embodiments are not limited to using the heatmaps described herein, and embodiments may employ various heatmaps alone or in combination.

FIG. 3A illustrates a first example heatmap 330. The heatmap 330 is a distance heatmap that illustrates scores to achieve an objective of placing objects close to piperacks. If equipment is far away from piperacks, the equipment needs more piping to reach the piperacks. Low scores are assigned to locations that are occupied by piperacks and/or equipment. Higher scores are assigned at unoccupied locations near piperacks, especially near junctions. In an embodiment, an end user interactively provides a minimum distance between a piece of equipment and a piperack.

According to an embodiment, the distance heatmap 330 assigns a score (as shown by the scale 333) to each gridpoint (x,y) (composed of an x-dimension 331 and a y-dimension 332, of the environment) depending on how close the point is to the piperacks in the layout. The heuristic this example heatmap 330 accomplishes is placing equipment closer to a piperack 335 in order to minimize piping needed to connect the equipment to other equipment. In heatmap 330, there is a higher bias the closer a point is to the midline of a piperack 335 (for example, at location 334), Thus, according to the heatmap 330, placing equipment closer to piperacks is more favorable. According to an embodiment, the score at each (x,y) is the sum of the inverses of distances from that point to the closest points on each piperack. In embodiments, the scores are normalized to be in the range [−1,1]. Locations on top of piperacks and on top of equipment already placed are automatically assigned scores of −1.

To illustrate the example heatmap 330, the location 334 is very close to the piperack 335 and, thus, the location 334 has a score of 1 in accordance with the scale 333.

FIG. 3B illustrates another example distance heatmap 340 in which scores are assigned (as shown by the scale 343) to each gridpoint (x,y) (composed of an x-dimension 341 and a y-dimension 342, of the environment) depending on how close the point is to the junctions of piperacks in the layout. In heatmap 340, there is a higher bias (for example, at location 346) the closer a point is to the junction of piperack 344 and piperack 345.

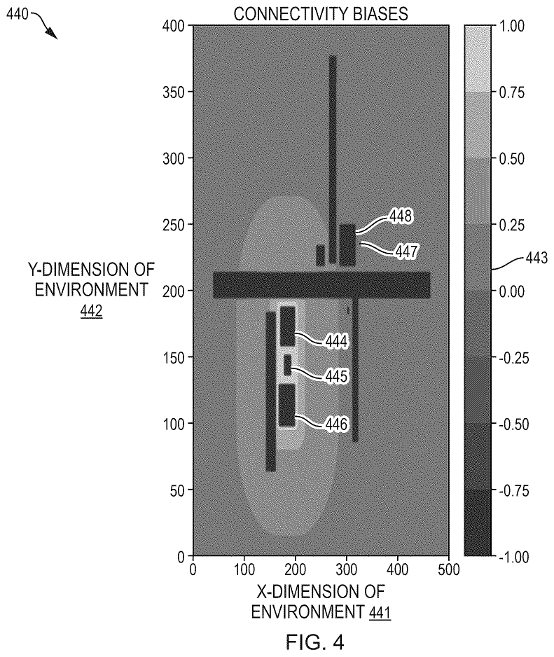

FIG. 4 shows an example of a connectivity heatmap 440. In the connectivity heatmap 440, higher scores are assigned when certain equipment are connected to each other and should be close to each other to minimize piping. In other situations, certain equipment are not directly connected to each other, but should still be near to each other because they both belong to the same subsystem or group. The heatmap 440 achieves these objectives.

According to an embodiment, the connectivity heatmap 440 assigns a score (as shown by the scale 443) to each gridpoint (x,y) (composed of an x-dimension 441 and a y-dimension 442, of the environment) depending on how close the point is to all the equipment in E (i.e., equipment in the environment) that are connected to q (the object for which a location is being determined). The heuristic this example heatmap 440 implements is scoring locations for an object q that minimizes distances between the object q and other equipment already in the layout E that q is connected to. The heatmap 440 minimizes the piping needed to connect q to other equipment. Thus, according to the heatmap 440, placing an object q closer to other equipment in E that q is connected to is favorable. According to an embodiment, the score at each (x,y) is the sum of the inverses of distances from that point to the centers of each connected equipment in the layout. The scores are then normalized to be in the range [−1,1].

To illustrate the connectivity heatmap 440, consider an example where a location for an object A is being determined based on connectivity. In this example, the object A is going to be connected to objects 444-446. As such, locations for the object A that are close to equipment 444-446 already in the layout are higher, as shown by the shade/color-coding indicated by the scale 443. Placing object A closer to equipment 447 and 448 is less favorable (as shown by the lower scores) as object A is not connected to equipment 447 and 448.

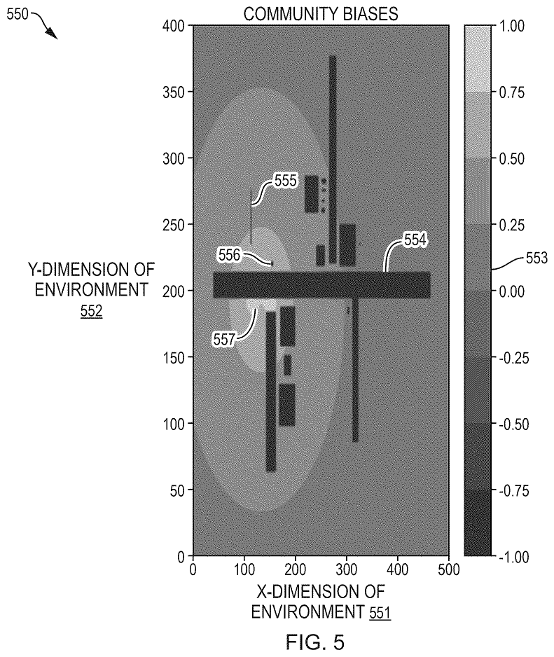

FIG. 5 shows an example of a community or grouping heatmap 550. According to an embodiment, the community heatmap 550 assigns a score (as shown by the scale 553) to each gridpoint (x,y) (composed of an x-dimension 551 and a y-dimension 552, of the environment) depending on how close the point is to the equipment in E (i.e., equipment in the environment) that are in a same “community” as q (the object for which a location is being determined. According to an embodiment, objects in a same “community” are objects that belong to a same subsystem and may or may not be directly connected. The heuristic this example heatmap 550 implements is favoring locations for an object q that are closer to other objects already in the layout that belong to the same community as q. The heatmap 550 ensures that a community of objects is not spread out. Generating layouts where objects in a community are not spread apart yields layouts that are more organized and likely decreases piping usage. Thus, placing an equipment q closer to other equipment in its community is favorable according to the heatmap (scoring metric) 550.

Additionally, to prevent so-called off-rack piping (i.e., piping that goes directly between equipment rather than through piperacks), the heatmap 550 can also bias an opposite side of the nearest piperack to each of the other equipment in the same community as q (i.e., a side across a piperack from a location). According to an example scoring function that implements this biasing, the score at each (x,y) is the sum of the inverse of distances from that point (x,y) to an opposite side of the nearest piperack to each of the other equipment in the same community as q. The scores can also be normalized to be in the range [−1,1].

To illustrate the community heatmap 550 and biasing, consider an example where a location for an object A is being determined. In this example, the object 554 is a piperack and objects 555 and 556 belong to the same community as the object A. As shown in FIG. 5, a bias is placed on the opposite side of the piperack 554 (e.g., at location 557) to minimize off-rack piping and near objects 555 and 556 which are in the same community as the object A (i.e., the object for which a location is being determined.

Embodiments may use various software applications and algorithms to determine groupings and communities of objects. These include, without limitation, Aspen HYSYS® (by Applicant-Assignee AspenTech Corporation) flowsheets, graph partitioning algorithms, clustering algorithms, and density-based methods.

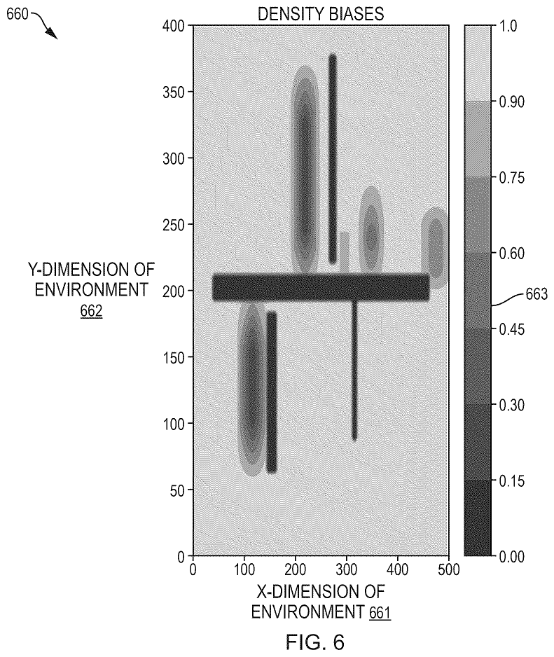

FIG. 6 shows an example of a density heatmap 660. According to the density heatmap 660 scoring function, higher scores indicate a lower probability of overlapping objects. The heatmap 660 allows users to identify locations where objects could overlap, thereby mitigating the formation of any dense clusters and ensuring better accessibility to the objects. According to an embodiment, the density at each gridpoint is the ratio of overlapping areas of objects if an object was to be placed at that gridpoint. For example, if an object is already placed at a grid location, the density map would represent the fraction of the area occupied by the object.

In some embodiments, the density heatmap 660 assigns a score (as shown by the scale 663) to each gridpoint (x,y) (composed of an x-dimension 661 and a y-dimension 662, of the environment) depending on how dense each point in the layout is. The heuristic this example heatmap 660 implements is scoring locations lower when placement of an object increases density. This ensures that layouts are determined in which objects will be accessible to humans for maintenance and pipe routing will be less convoluted. Further, the density heatmap 660 prevents a large concentration of equipment in any region of the layout. According to an example embodiment of the heatmap 660, the score at each (x,y) is the ratio of overlapping areas of equipment if q (the object for which locations are being evaluated) were to be placed at (x,y). An embodiment normalizes the scores in the range [0,1]. Further, according to an embodiment, locations on top of piperacks are automatically assigned scores of 0.

In an embodiment, based on one or more scores, an aggregated, i.e., overall score for each determined available location (e.g., gridpoint) is calculated. An embodiment generates a penultimate heatmap based on the aggregated scores. To smooth out the scores, the penultimate heatmap may be convolved with a smoothing kernel with size equal to the dimensions of a set of objects (e.g., equipment q) to produce the final heatmap.

According to another embodiment, before producing the final heatmap, one or more constraints may also be applied to one or more individual scores to produce an overall score for each determined available location. In an embodiment, an end user interactively specifies constraints. An example constraint that may be applied is a distance constraint which reduces scores of locations that constitute distance constraint violations for a set of objects. Embodiments may use modified versions of scoring functions (modified in comparison to scoring functions used to generate individual heatmaps) when generating aggregated heatmaps. One or more of the same type of constraints may be adjusted when producing a heatmap, depending on the type of heatmap being generated. For example, an embodiment may produce a distance constraint heatmap and enforce the distance constraint more at the beginning (e.g., when generating individual scores and heatmaps) and less at the end (e.g., when producing a final heatmap). This may prevent the placement of equipment in isolated locations.

Another constraint that may be applied when determining an aggregated heatmap is a constraint that discourages placements of objects at ends of piperacks even if there is available space. Such a constraint may be applied to avoid placing objects at the ends of an environment layout (the ends of piperacks are typically the ends of environments). Such an embodiment may locate the nearest piperack to each gridpoint (x,y) and set the gridpoint's score to the lowest limit (e.g., −1) if that gridpoint is beyond the end of the nearest piperack.

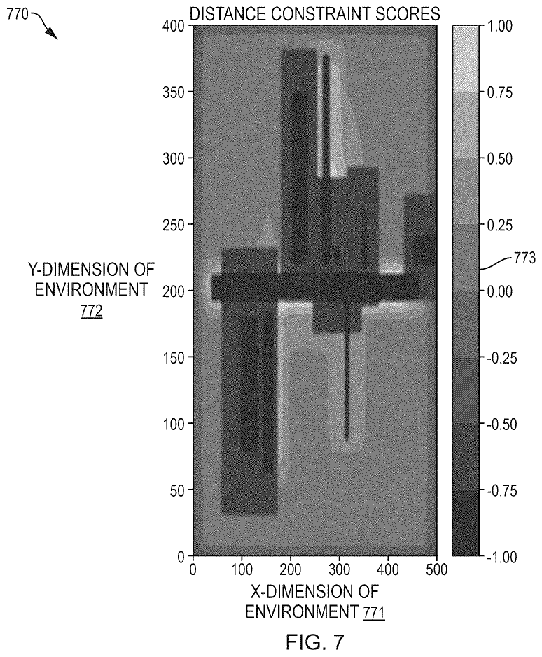

FIG. 7 shows a final heatmap 770 that is based on the individual heatmaps 330, 340, 440, 550, and 660, described hereinabove. In the heatmap 770, each gridpoint (x,y) (composed of an x-dimension 771 and a y-dimension 772, of the environment) has a score (as shown by the scale 773). An embodiment utilizes the scores to determine object locations. In an embodiment, the larger the overall score is, the more optimal it would be to place the object at that location. According to an embodiment, an object is placed at a location wherever the final heatmap is maximized. If the object does not physically fit at that location, an attempt is made to place the object at the second maximum, and so on, until the object physically fits at a location.

Embodiments may also determine object locations using a genetic-style method. An example genetic-style method produces multiple random layouts. From amongst the multiple layouts, layouts that satisfy defined constraints and have more optimal KPIs are kept and any remaining layouts are discarded. The layouts that are kept are mated together to produce a next generation of layouts. The mating process, according to an embodiment, comprises taking qualities from multiple layouts and combining them, as well as introducing extra randomness into the layouts, so that the best qualities of the layouts of a particular generation are then passed on to the next generation. This process may be performed for a specific number of generations, which yields layouts that have near-optimal KPI values.

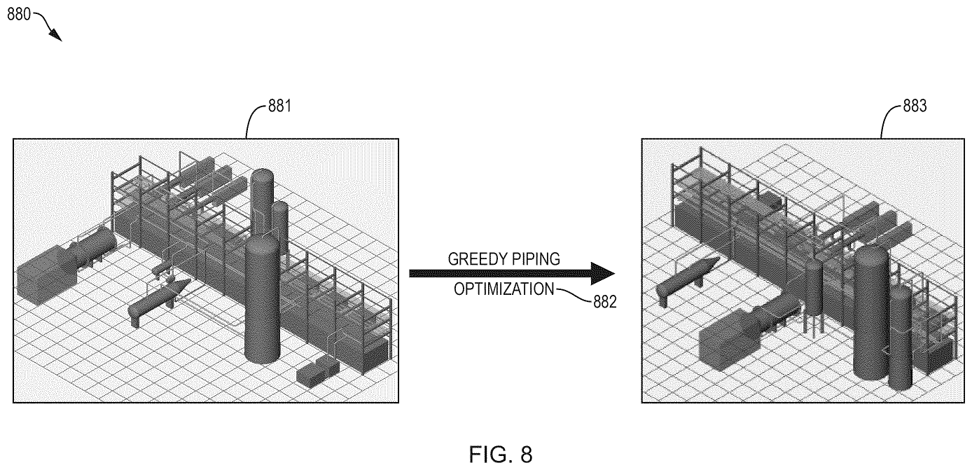

In an embodiment, after each object is assigned a location via the heatmap approach, e.g., method 100, or a genetic-style method and a layout is generated, a greedy KPI optimization may be used to modify the layout. FIG. 8 illustrates one such example method 880. The method 880 starts with an existing layout 881 and applies a greedy KPI optimization 882. In this way, greedy KPI optimization is used to alter locations of equipment according to KPI. The greedy KPI optimization 882 incrementally improves the layout 881 by moving each equipment grecdily so that a specific KPI is minimized. In one such embodiment, the KPI optimization 882 produces a heatmap where the score at each location is what the KPI value would be if a particular object is moved to that location. Such an embodiment, thus, can greedily optimize a particular KPI starting with an existing layout 881, instead of starting from scratch. Applying the greedy KPI optimization 882 produces a finalized layout 883. Further, such an embodiment may produce a heatmap that visualizes KPI values at each gridpoint.

### EXAMPLE APPLICATIONS

Embodiments disclosed herein can be used to generate a layout of objects for any environment. However, embodiments may be particularly advantageous when applied to chemical plant environments. In what follows, examples of applying embodiments successfully in chemical plant environments are elucidated.

### Example 1: Layouts

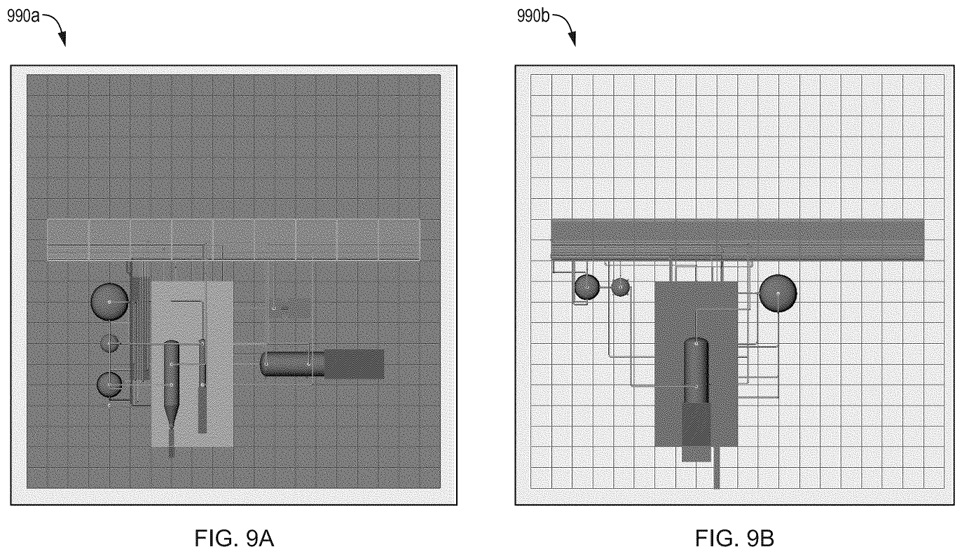

FIGS. 9A and 9B illustrate example layouts 990a and 990b, respectively. The layout 990a is a human designed layout while the layout 990b was designed using an embodiment, e.g., the method 100.

It is noted that the layout 990b outperforms the human designed layout 990a in terms of piping distance as shown in Table 1.

In the tables herein, e.g., Table 1, Table 2, etc., “Total lines” represents an ideal number of piping lines, while “routed lines” indicates the number of successful piping lines determined by a pipe-routing algorithm in Aspen OptiPlant®. Any discrepancies (e.g., failed lines) may be addressed during post-processing.

Further, in the tables herein, spacing violations refer to the number of spacing constraints (e.g., based on one or more conditions or criteria) that are not satisfied by the layout, e.g., number of pairs of objects that are closer together than a pre-specified limit provided as input.

TABLE 1
Piping Distances, Routed Lines, Total Lines, and
Spacing Violations For Layouts 990a and 990b.

| | Total Piping Distance | |
|---|---|---|
| | (km) (Routed | Spacing |
| Layout | Lines/Total Lines) | Violations |
| Human (990a) | 1.3 (30/30) | 6 |
| AI (990b) | 1.2 (30/30) | 10 |

### Example 2: Layouts

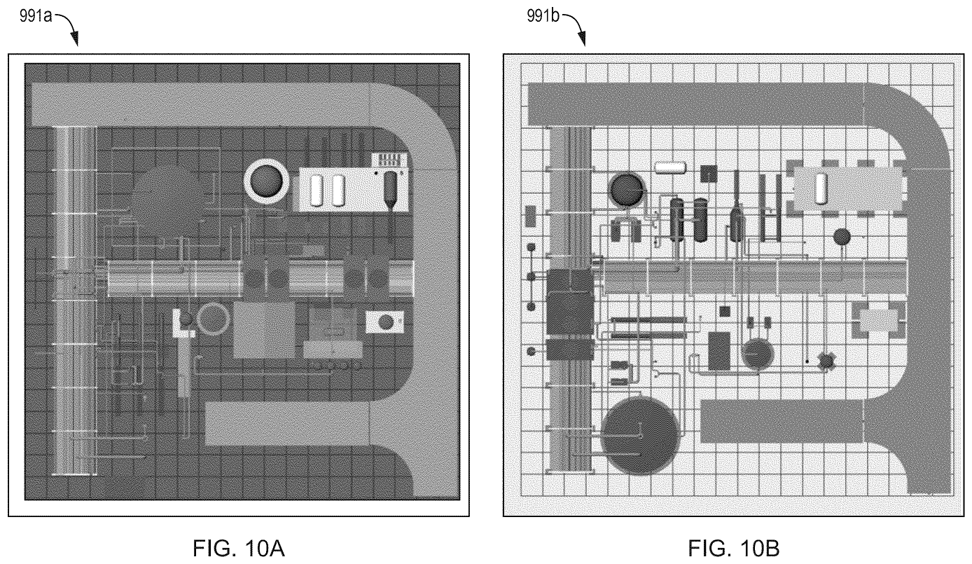

FIGS. 10A and 10B illustrate example layouts 991a and 991b, respectively. The layout 991a is a human designed layout while the layout 991b was designed using an embodiment, e.g., the method 100.

Table 2 shows a comparison between the human designed layout 991a and the layout 991b. Layout 991b uses less piping and has fewer spacing violations than layout 991a. There is also no discrepancy between the number of routed lines and total lines for layout 991b.

TABLE 2
Piping Distances, Routed Lines, Total Lines, and
Spacing Violations For Layouts 991a and 991b.

| | Total Piping Distance | |
|---|---|---|
| | (km) (Routed | Spacing |
| Layout | Lines/Total Lines) | Violations |
| Human (991a) | 1.8 (90/91) | 27 |
| AI (991b) | 1.72 (74/74) | 17 |

### Example 3: Layouts

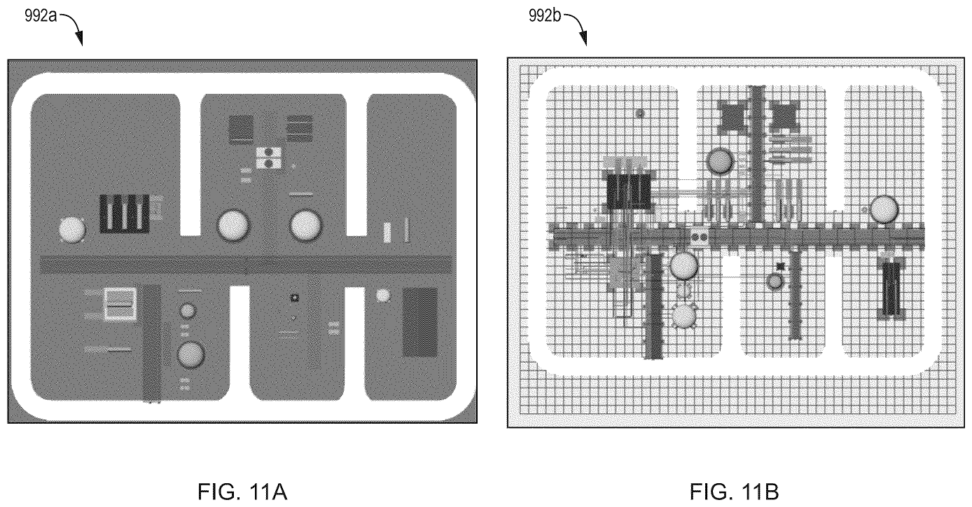

FIGS. 11A and 11B illustrate example layouts 992a and 992b, respectively. The layout 992a is a human designed layout while the layout 992b was designed using an embodiment, e.g., the method 100.

Table 3 shows a comparison between the human designed layout 992a and layout 992b. While layout 992b requires more piping than layout 992a, layout 992b was produced in under one minute, whereas layout 992a took at least a week to design.

TABLE 3
Piping Distances, Routed Lines, Total Lines, and
Spacing Violations For Layouts 992a and 992b.

| | Total Piping Distance | |
|---|---|---|
| | (km) (Routed | Spacing |
| Layout | Lines/Total Lines) | Violations |
| Human (992a) | 3.4 (120/123) | 23 |
| AI (992b) | 5.2 (120/123) | 23 |

### Example 4: Option Engineering-Generate Multiple Layouts by Changing Order of Equipment Placement

For a given order of equipment, the generated layout is deterministic. In order to generate different layouts, the order of placing the equipment is altered.

Equipment placed down earlier has better access to piperacks, connected equipment, and fewer distance constraints to interfere with its placement. The sequence of equipment placement may depend on the functional role of equipment. For example, equipment may be placed in order of: 1) Priority (e.g., priorities of all equipment are considered, regardless of group); 2) Subgroup Priority (e.g., groups are ordered by number of members and the placement order of each individual member is determined by priority); and 3) Size (e.g., physical size, larger equipment may be more important). In an embodiment, a user provides an indication of characteristics to consider when determining equipment location.

FIGS. 12A-C show example layouts (i.e., priority layout 993a, subgroup priority layout 993b, and size layout 993c) that were determined using embodiments based on placing the equipment in order of priority, subgroup priority, or size. In other words, the layouts 993a-c were determined using embodiments where each layout was determined using a different priority between objects.

Table 4 shows piping distances, the number of routed lines with respect to the number of total lines, and the number of spacing violations for priority layout 993a, subgroup priority layout 993b, and size layout 993c.

TABLE 4
Piping Distances, Routed Lines, Total Lines, and
Spacing Violations for Priority Layout 993a, Subgroup
Priority Layout 993b, and Size Layout 993c.

| | Total Piping | Routed Lines/ | Spacing |
|---|---|---|---|
| Layout | Distance (km) | Total Lines | Violations |
| Priority (993a) | 1.04 | 29/30 | 0 |
| Subgroup Priority (993b) | 1.08 | 29/30 | 0 |
| Size (993c) | 1.02 | 28/30 | 0 |

### Example Advantages

Explainable. Embodiments provide an interpretable application of machine learning methods to solve the equipment layout problem. For example, a final heatmap shows a visualization of equipment placement, and the individual heatmaps show contributions of various criteria to the equipment placement of the final heatmap. Heatmap results are more explainable and transparent than other methods, by virtue of heatmap visualizations.

Speed. Embodiments can determine layouts quickly because they do not rely upon complex calculations. Further, embodiments can be parallelized to provide even faster results.

Customizable. Embodiments offer modularity and allow for customization. In embodiment, heatmaps can be added or modified to suit different layout requirements or criteria.

Parallelized. Since, in an embodiment, individual heatmaps are independent of each other, their generation can be performed in parallel so as to significantly reduce computation time and streamline the layout optimization process.

Embodiments are an improvement over prior art methods. Amongst other advantages, embodiments provide an interpretable application of computational and machine learning methods to solve the equipment layout problem. This is accomplished using scoring functions that scores different locations for each equipment on multiple criteria. Scores can be visualized via heatmaps which can be produced quickly without high computational cost. The heatmaps are also modular, thereby simplifying the production of additional heatmaps or the removal of existing heatmaps.

Embodiments may be used to modify or establish real-world object layouts. For instance, a measurement of a real-world environment may be obtained and, likewise, measurements of real-world objects to be arranged in the environment may be obtained. In turn, embodiments may be used to determine a layout for the real-world objects in the real-world environment. Similarly, embodiments may be used where objects are already arranged in an environment. Specifically, measurements of the objects and environment may be obtained and, in turn, embodiments may be utilized to determine an improved layout of the objects.

### Computer Support

FIG. 13 illustrates a computer network or similar digital processing environment in which embodiments of the present disclosure may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

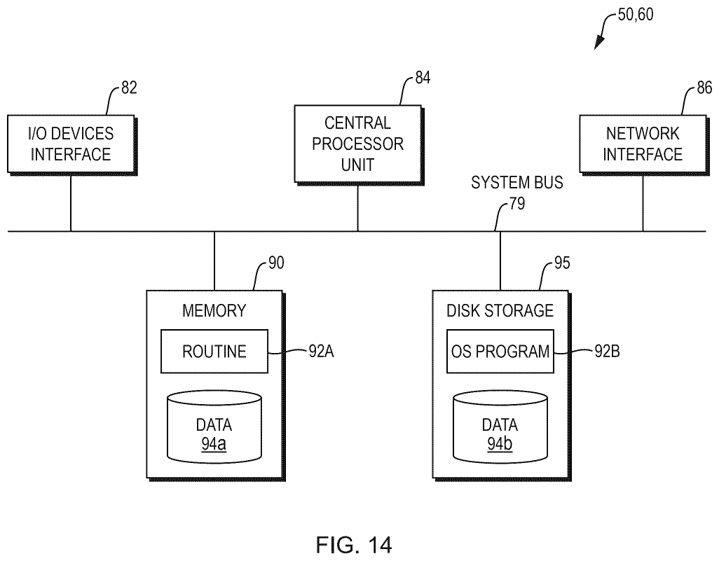

FIG. 14 is a diagram of an example internal structure of a computer (e.g., client processor/device 50 or server computers 60) in the computer system of FIG. 13. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 13). Memory 90 provides volatile storage for computer software instructions 92A and data 94a used to implement an embodiment of the present disclosure. The computer software instructions can implement the methods and operations of the methods described herein, e.g., the methods 100 and/or 220 detailed above. Disk storage 95 provides non-volatile storage for computer software instructions 92B and data 94b used to implement an embodiment of the present disclosure. The computer software instructions can implement the methods and operations of methods detailed herein. A central processor unit 84 is also attached to the system bus 79 and provides for the execution of computer instructions.

In one embodiment, the processor routines 92A-B and data 94a-b are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for an embodiment. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92A-B.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

While example embodiments have been particularly shown and described, it will be understood by those skilled in the art that various changes in form and details may be made therein without departing from the scope of the embodiments encompassed by the appended claims.

For example, the foregoing description and details of embodiments in the figures reference Applicant-Assignee (AspenTech Corporation), tools and platforms, for purposes of illustration and not limitation. Other similar tools and platforms are suitable.

The teachings of all patents, published applications and references cited herein are incorporated by reference in their entirety.

What is claimed is:

1. A computer-implemented method of determining a layout of a set of objects in an environment, the method comprising, by a processor:
receiving, in memory, (i) an indication of the set of objects, (ii) an indication of characteristics of the environment, and (iii) one or more criteria;
using the received indication of the set of objects and the one or more criteria, determining a priority order of each object in the set of objects; and
determining the layout of the set of objects by, in the determined priority order, iteratively selecting a location for each object, wherein selecting the location for each object comprises:
based on the received indication of characteristics of the environment, determining available locations in the environment;
based on at least one of the received indication of characteristics of the environment and the one or more criteria, assigning one or more scores to each determined available location in the environment for the object; and
based on the assigned one or more scores of each determined available location for the object, selecting a given location for the object.

2. The computer-implemented method of claim 1, wherein the one or more criteria includes at least one of: an indication of dimensions of an object, an indication of a grouping of objects, and an indication of a direct connection between objects.

3. The computer-implemented method of claim 1, wherein the characteristics of the environment comprise one or more of: distance of an object to a piperack, connectivity between two or more objects, an indication of a grouping of objects, and density of objects.

4. The computer-implemented method of claim 1 further comprising:
generating a visualization of the environment indicating the assigned one or more scores for each determined available location for the object.

5. The computer-implemented method of claim 1 further comprising:
receiving, in the memory, an indication of one or more key performance indicators; and
modifying the determined layout of the set of objects by iteratively modifying the location for each object, wherein modifying the location for each object comprises:
based on the received indication of one or more key performance indicators, assigning one or more scores to each determined available location in the environment for the object; and
based on the assigned one or more scores of each determined available location for the object, modifying the location for the object.

6. The computer-implemented method of claim 5, wherein the one or more key performance indicators is at least one of: amount of piping, layout size, production volume, and manufacturing cycle time.

7. The computer-implemented method of claim 1, wherein the set of objects is a set of equipment.

8. The computer-implemented method of claim 7, wherein the set of equipment is a set of manufacturing equipment.

9. The computer-implemented method of claim 1, wherein assigning the one or more scores to each determined available location in the environment for the object comprises:
assigning a distance score, a connectivity score, a community score, and a density score to each determined available location in the environment.

10. A computer-based system for determining a layout of a set of objects in an environment, the system comprising:
a processor; and
a memory with computer code instructions stored thereon, the processor and the memory, with the computer code instructions, being configured to cause the system to:
receive, in the memory, (i) an indication of the set of objects, (ii) an indication of characteristics of the environment, and (iii) one or more criteria;
using the received indication of the set of objects and the one or more criteria, determine a priority order of each object in the set of objects; and
determine the layout of the set of objects by, in the determined priority order, iteratively selecting a location for each object, wherein selecting the location for each object comprises:
based on the received indication of characteristics of the environment, determining available locations in the environment;
based on at least one of the received indication of characteristics of the environment and the one or more criteria, assigning one or more scores to each determined available location in the environment for the object; and
based on the assigned one or more scores of each determined available location for the object, selecting a given location for the object.

11. The computer-based system of claim 10, wherein the one or more criteria includes at least one of: an indication of dimensions of an object, an indication of a grouping of objects, and an indication of a direct connection between objects.

12. The computer-based system of claim 10, wherein the characteristics of the environment comprise one or more of: distance of an object to a piperack, connectivity between two or more objects, an indication of a grouping of objects, and density of objects.

13. The computer-based system of claim 10 wherein, the processor and the memory, with the computer code instructions, are further configured to cause the system to generate a visualization of the environment indicating the assigned one or more scores for each determined available location for the object.

14. The computer-based system of claim 10 wherein, the processor and the memory, with the computer code instructions, are further configured to cause the system to:
receive, in the memory, an indication of one or more key performance indicators; and
modify the determined layout of the set of objects by iteratively modifying the location for each object in the set of objects, wherein modifying the location for each object comprises:
based on the received indication of one or more key performance indicators, assigning one or more scores to each determined available location in the environment for the object; and
based on the assigned one or more scores of each determined available location for the object, modifying the location for the object.

15. The computer-based system of claim 14, wherein the one or more key performance indicators includes at least one of: amount of piping, layout size, production volume, and manufacturing cycle time.

16. The computer-based system of claim 10, wherein the set of objects is a set of equipment.

17. The computer-based system of claim 16, wherein the set of equipment is a set of manufacturing equipment.

18. The computer-based system of claim 10 wherein, in assigning the one or more scores to each determined available location in the environment for the object, the processor and and the memory, with the computer code instructions, are configured to cause the system to:
assign a distance score, a connectivity score, a community score, and a density score to each determined available location in the environment.

19. A computer program product for determining a layout of a set of objects in an environment, the computer program product comprising at least one non-transitory computer-readable storage medium providing at least a portion of computer code instructions that, when executed by a processor, cause an apparatus associated with the processor to:
receive, in memory, (i) an indication of the set of objects, (ii) an indication of characteristics of the environment, and (iii) one or more criteria;
using the received indication of the set of objects and the one or more criteria, determine a priority order of each object in the set of objects; and
determine the layout of the set of objects by, in the determined priority order, iteratively selecting a location of each object, wherein selecting the location of each object comprises:
based on the received indication of characteristics of the environment, determining available locations in the environment;
based on at least of the received indication of characteristics of the environment and the one or more criteria, assigning one or more scores to each determined available location in the environment for the object; and
based on the assigned one or more scores of each determined available location for the object, selecting a given location for the object.

20. The computer program product of claim 19, wherein the computer code instructions, when executed by the processor, further cause the apparatus associated with the processor to generate a visualization of the environment indicating the assigned one or more scores for each determined available location for the object.
